(19) United States
(12) Patent Application Publication
(10) Pub. No.: US 2004/0057373 A1
(43) Pub. Date: Mar. 25, 2004

(54) Pickup feed mechanism and disk drive comprising the same

(76) Inventors: Eiji Hoshinaka, Tokorozawa-shi (JP); Keiichi Takagi, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/628,570

(22) Filed: Jul. 29, 2003

(30) Foreign Application Priority Data
Jul. 29, 2002 (JP) 2002-220405

(51) Int. Cl. G11B 17/30; G11B 21/02; G11B 17/00; G11B 21/16

(52) U.S. Cl. 369/223; 369/249

(57) ABSTRACT

Disclosed herein is a pickup feed mechanism in which the joint and the feed screw can engage with each other in a desirable manner. The joint (23) is fastened at one end to a slide member (21) that holds a pickup. The joint (23) has, at the other end, an engagement part (231) that is shaped like a projection. The engagement part (231) is located between a top cover (32) and the feed screw (24) and engaged with the screw portion (241) of the feed screw (24). The joint (23) also has, as the other end, a projection (232) that protrude away from the engagement part (231). The projection (232) abuts on the top cover (32) before the engagement part (231) disengages from the screw portion (241), when the joint (23) moves away from the screw portion (241) as it receive vibration or an impact. Thus, the engagement part (231) is prevented from coming out of the screw portion (241).

### BACKGROUND OF THE INVENTION

1. Field of the Invention

The present invention relates to a pickup feed mechanism and a disk drive comprising the pickup feed mechanism.

2. Description of the Related Art

A disk drive for reproducing data recorded on optical disks, magnetic disks or the like generally performs reproduction of data on a disk by rotating the disk and simultaneously moving a pickup in the radial direction of the disk. The pickup is so moved by using a slide member and a feed screw. The slide member holds the pickup and can be moved in the radial direction of the disk. The feed screw extends parallel to the direction in which the slide member is moved. The feed screw is coupled at one end to an electric motor. A joint is mounted on the slide member. The feed screw is set in engagement with the joint. The joint is positioned between the slide member and the feed screw. One end of the joint is secured to the slide member and the other end is pushed onto the feed screw with an appropriate bias. In such a pickup feed mechanism, when the motor is driven, the joint is moved by the turn of the feed screw so that the slide member moves parallel to the feed screw.

According to the above-described pickup feed mechanism, the joint is pushed onto the feed screw with an appropriate bias to be kept in desirable engagement with the feed screw. The bias applied on the joint is adjusted by a spring secured to the joint. The smaller the bias is, the more readily the slide member can move. If the bias is too small, however, the joint may come out of engagement with a screw portion of the feed screw. In this case, the pickup feed mechanism can no longer operate as is desired.

### SUMMARY OF THE INVENTION

An object of the present invention is to provide a pickup feed mechanism in which the joint and the feed screw can engage with each other in a desirable manner and a disk drive comprising the mechanism.

A pickup feed mechanism according to the present invention comprises: a slide member holding a pickup for recording and/or reproducing data on and from a disk-shaped recording medium and configured to move the pickup in a radial direction of the disk-shaped recording medium; a feed screw extending parallel to a direction in which the slide member is moved; a rotation drive configured to rotate the feed screw; a joint having one end secured to the slide member, the other end intersecting with a pivot of the feed screw, and one side engaged with the screw portion of the feed screw; and a holding member arranged in the position to prevent the joint from coming out of the screw portion of the feed screw, wherein the holding member is a case member which contains the pickup, the slide member, the feed screw, the rotation drive, and the joint.

A disk drive according to the present invention comprises a pickup feed mechanism of the type described above.

### BRIEF DESCRIPTION OF THE DRAWINGS

FIG. 1 is a plan view entirely showing a disk drive according to an embodiment of the present invention;

FIG. 2 is a plan view showing a pickup feed mechanism provided in the embodiment;

FIG. 3 is a side view of the joint incorporated in the pickup feed mechanism provided in the embodiment;

FIGS. 4A and 4B are diagrams illustrating how the joint works;

FIG. 5 is a plan view of a modification of the joint shown in FIG. 3; and

FIG. 6 is a side view of the modified joint.

### DETAILED DESCRIPTION OF THE PREFERRED EMBODIMENTS

An embodiment of the present invention will be described, with reference to the accompanying drawings.

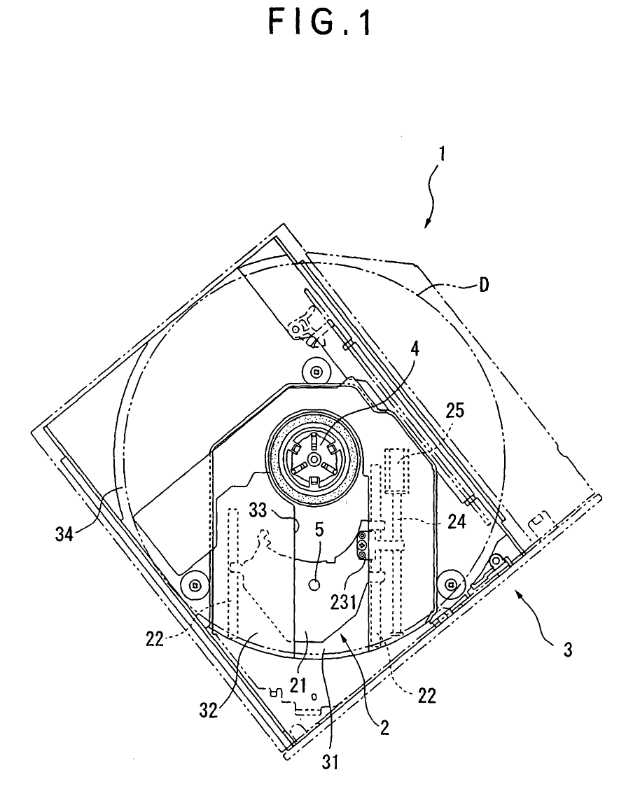

FIG. 1 is an entire view showing a disk drive 1 according to the embodiment, which comprises a pickup feed mechanism 2.

As FIG. 1 shows, the disk drive 1 comprises a flat tray 34 on which a disk-shaped recording medium D can be placed. A case 3 for accommodating the pickup feed mechanism 2 is provided on the opposite side of the surface of the tray 34 on which a disk-shaped recording medium is placed. The case 3 comprises a bottom case 31 and a top cover 32. The bottom case 31 has a flat part and an opening. The flat part extends parallel to the tray 34. The top cover 32 is flat and can shut the opening of the bottom case 31. The bottom case 31 contains the pickup feed mechanism 2. The top cover 32 is fitted in the opening of the tray 34 and lies on the same level as the tray 34. The bottom case 31 has a disk-holding part 4. The disk-holding part 4 can hold the disk-shaped recording medium D, allowing the medium D to rotate. The disk-holding part 4 is exposed outside through an opening 33 formed in the top cover 32. The opening 33 extends from the disk-holding part 4 and the fringe thereof toward the radial direction of the disk-shaped recording medium D. The opening 33 exposes a part of the pickup feed mechanism 2.

The disk-shaped recording medium D can be an optical disk, an optomagnetic disk, a magnetic disk, or the like. The disk drive 1 is a so-called “slim drive” that is thin, in which the components (including the pickup feed mechanism 2) are arranged approximately within the diameter of the disk-shaped recording medium D and parallel to the recording surface of the medium D, i.e., parallel to a flat surface of the top cover 32.

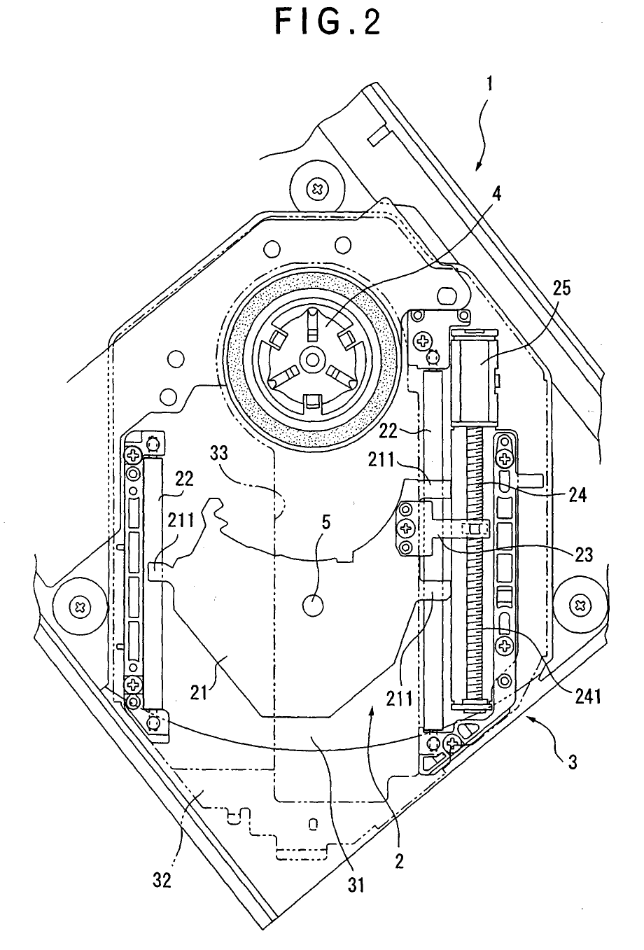

As FIG. 2 shows, the pickup feed mechanism 2 comprises a slide member 21 and a feed screw 24. The slide member 21 is a flat plate that holds a pickup 5. The feed screw 24 can move the slide member 21 in the radial direction of the disk-shaped recording medium D.

The slide member 21 holds the pickup 5 approximately at its center part. The pick 5 is exposed outside through the opening 33. Hence, the pickup 5 can make access to the disk-shaped recording medium D.

Two support members 22 shaped like a rod are provided, extending parallel to the direction in which the slide member 21 can move and spaced apart along the diameter of the disk-shaped recording medium D. Two guide parts 211 are formed integral with the slide member 21 and provided at the ends of the member 21. The guide parts 211 engage with the support members 22, respectively. This enables the slide member 21 to move in the radial direction of the disk-shaped recording medium D.

The guide parts 211 may be formed by curling a part of of the slide member 21. Alternatively, the guide parts 211 may be formed like a hollow cylinder having support members 22 inside thereof to be slidably moved. In this embodiment, the guide part 211 located near the feed screw 24 comprises two hollow cylinders that are slidably supported by the support member 22. This support member 22 has a circular cross section. The other guide part 211 located far from the feed screw 24 is a flat plate that is abbutingly supported by the other support member 22.

The feed screw 24 extends parallel to the direction in which the slide member 21 moves. The feed screw 24 has a screw portion 241 having a helical groove cut in its circumferential surface. The screw 24 is coupled at one end to a stepping motor 25, which serves as rotation drive.

Note that the pitch of the screw portion 241 and the rotation speed of the stepping motor 25 are appropriately determined on the basis of the rotational speed of the disk-shaped recording medium D and the speed of feeding the pickup 5 (i.e., seek speed).

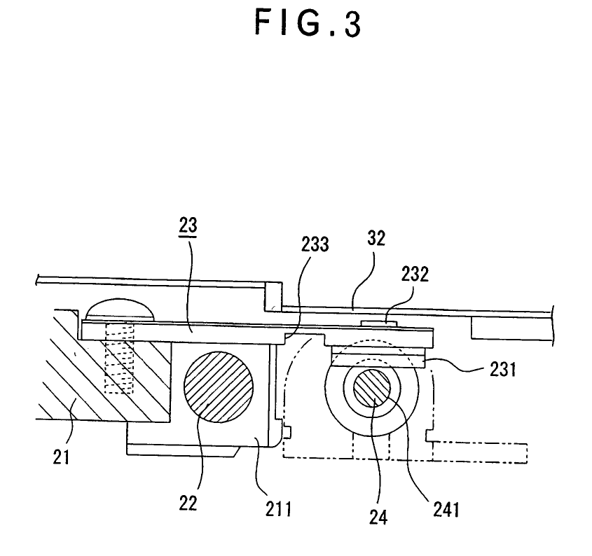

The feed screw 24 is engaged with the slide member 21 through a joint 23 mounted on the slide member 21. As illustrated in FIG. 3, too, the joint 23 is a flat, T-shaped plate. It consists of a broad proximal part and a narrow and long distal part. The proximal part of the joint 23 is fastened to the slide member 21 by means of screws or the like.

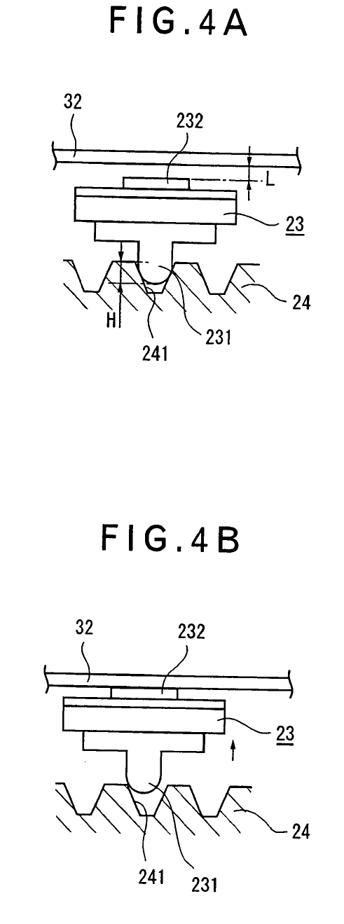

The joint 23 is composed of a metal plate and a synthetic-resin plate. The synthetic-resin plate is adhered to the metal plate in this embodiment. The joint 23 has an engagement part 231 on the lower surface of the distal part. The part 231 is set in engagement with the screw portion 241 of the feed screw 24. As FIG. 4A shows, the engagement part 231, which is a projection formed on a longitudinal side surface of the joint 23, extends at right angles to the pivot of the feed screw 24 and engages with that part of the screw portion 241 which faces the top cover 32. The joint 23 has a recess 233 made in the center part of the synthetic-resin plate. The recess 233 has such a size and shape as to adjust the bias with which the joint 23 is pushed onto the screw portion 241. Thus, the joint 23 is pushed onto the screw portion 241 with an appropriate bias and can move toward and away from the screw portion 241. A substantially rectangular projection 232 is provided on that surface of the joint 23 which is opposite to the surface which faces the feed screw 24, or which faces away from the screw portion 241. This projection 232 lies between the top cover 32 and the feed screw 24. The gap L between the projection 232 and the top cover 32 is smaller than the depth H of at which the engagement part 231 engages with the screw portion 241 of the feed screw 24.

How the embodiment operates will be described below.

A disk-shaped recording medium D is placed on the tray 34. The medium D is rotated by the disk-driving mechanism (not shown). The stepping motor 25 is driven to move the pickup 5 in the radial direction of the disk-shaped recording medium D. The stepping motor 25 rotates the feed screw 24. The joint 23, which engages with the screw portion 241, moves parallel to the pivot of the feed screw 24. Since the joint 23 is fixed to the slide member 21, the slide member 21 slides on the support members 22. Since the pickup 5 is mounted on the slide member 21, it moves in the radial direction of the disk-shaped recording medium D.

While the slide member 21 is moving in a normal way, the engagement part 231 of the joint 23 remains engaged with the screw portion 241 as shown in FIG. 4A, by virtue of the appropriate bias. However, the joint 23 may be disengaged from the screw portion 241 as it receives vibration or impacts. In this case, the projection 232 abuts on the top cover 32 before the joint 23 is disengaged from the screw portion 241, thus preventing the engagement part 231 from slipping out of the screw portion 241. Namely, the top cover 32 serves as a holding member to prevent the engagement part 231 from coming out of the screw portion 241 in the present embodiment.

The present embodiment is therefore advantageous in the following respects.

First, the projection 232 of the joint 23 abuts on the top cover 32 before it slips out of the screw portion 241 and would not come out of the screw portion 241. This is because the distal part of the joint 23 extends at right angles to the pivot of the feed screw 24 and is set in engagement with the screw portion 241. Thus, the joint 23 always remains in good engagement with the feed screw 24, to feed the pickup 5 in a desirable manner.

Second, the engagement part 231 of the joint 23 need not be pushed onto the screw portion 241 with a large bias, because it would not come out of the screw portion 241. The bias applied to the joint 23 can be minimized. This also helps to feed the pickup 5 in a desirable manner.

Third, since the projection 232 is provided on the joint 23, even if the joint 23 contacts the top cover 32 when it receives vibration or impacts, the contact area will be small. Therefore, friction between the joint 23 and the top cover 32 can be minimized. This ensures smooth feeding of the pickup 5.

Fourth, the support members 22 enable the slide member 21 to move in a stable condition, because they extend along the two opposing sides of the slide member 21. Further, since the support members 22 are provided in the same plane, the disk drive can be made thinner.

Fifth, the joint 23 is simple in structure, because the joint 23 extends at right angles to the pivot of the feed screw 24 and its distal part is set in engagement with the screw portion 241 at the side surface of the joint 23. Therefore, the joint can be made with high precision even if its components are miniaturized. Hence, the pickup feed mechanism 2 can attain high quality, thanks to the dimension tolerance. The pickup feed mechanism 2 can therefore be used in so-called slim drives, without degrading its pickup-feeding performance. The mechanism 2 helps to render the disk drive 1 thin.

Sixth, since the top cover 32 functions as a holding member for preventing the engagement part 231 from coming out of the screw portion 241, there is no need to have another holding member. This also helps to make the disk drive 1 still thinner.

The present invention is not limited to the embodiment described above. Various changes and modifications can fall within the scope of the invention so long as they achieve the object of the invention.

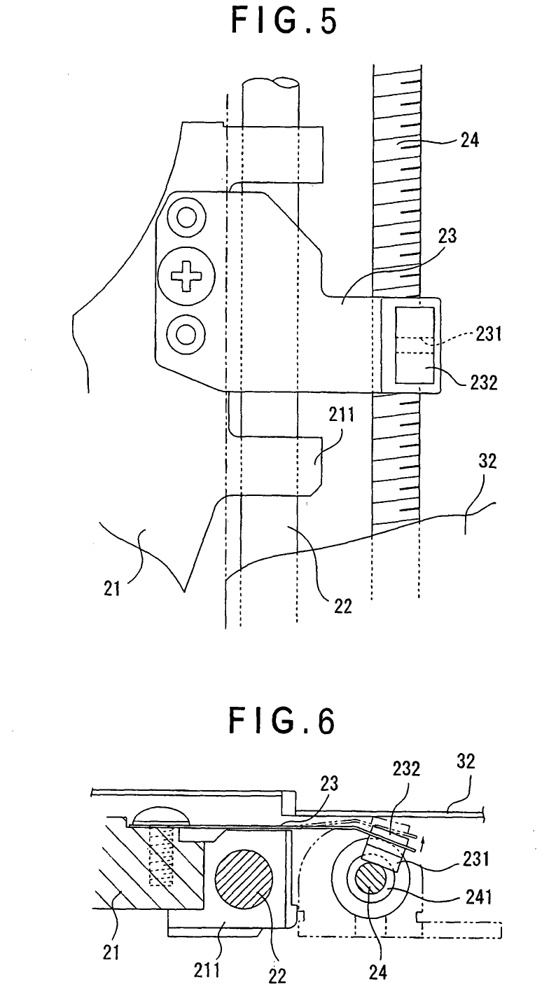

For example, the joint 23, which is composed of a metal plate and a synthetic-resin plate adhered to the metal plate and has a recess 233 made approximately in the center part in longitudinal direction, may be replaced by a joint of the type shown in FIGS. 5 and 6. The joint 32 shown in FIGS. 5 and 6 comprises a metal plate, an engagement part 231, and a projection 232. The part 231 and projections 232 are made of synthetic resin formed on the distal end of the metal plate by means of outsert molding. A recess (not shown) may be made by, for example, bending the center part of the metal plate. So shaped, the joint 32 can generate a bias only if it is bent. Thus, the joint 23 can be easily manufactured at low cost.

Alternatively, the joint 23 may be a metal plate only. In this case, the engagement part 231, projection 232 and recess 233 can be made by bending the metal plate. Comprising a single member and made by bending only, this joint 23 can be easily manufactured within a short time and hence at low cost.

As described above, the metal plate and the synthetic-resin plate, which constitute the joint 23, are adhered to each other. Instead, the synthetic-resin plate may be formed on the metal plate by means of outser molding. The metal plate and synthetic-resin plate can be secured to each other in any other appropriate method.

The structure of the joint 23 is not limited to the two-plate configuration described above. Rather, the joint 23 may be made of a metal plate only, or a synthetic-resin plate only. Further, the joint 23 may be made of any elastic material.

The projection 232 is substantially rectangular. Alternatively, it may be shaped like a disc, a sphere or a cone. Still alternatively, it may be so shaped as to line-contact the top cover 32. In short, the projection 232 can have whatever shape so long as it contacts the top cover 32 with small friction. Even if the projection 232 is not provided, a part of the joint 23 abuts on the top cover 32 to prevent the engagement part 231 from leaving the screw portion 241. If the joint 23 shown in FIGS. 5 and 6 does not have the projection 232, its bent portion will abut on the top cover 32 to assume in line-contact with the top cover 32. In this case, too, the engagement part 231 is prevented from moving away from the screw portion 241. This is why the projection 232 can be dispensed with.

The bias that pushes the engagement part 231 toward the screw portion 241 is not limited to the one that results from the elasticity of the joint 23. For example, a spring may be fastened at one end to the distal end of the joint 23 and at the other end to the bottom case 31. Then, the spring pulls the joint 23, thereby biasing the engagement part 231 toward the screw portion 241. The engagement part 231 can be biased toward the screw portion 241 in any other manner that is desirable.

Even if the engagement part 231 is not biased onto the screw portion 241, the top cover 32 prevents the part 231 from coming out of the screw portion 241. The engagement part 231 and the screw portion 241 therefore engage with each other in a desirable condition. In view of this, it is not always necessary to bias the engagement part 231 toward the screw portion 241.

The engagement part 231 extends at right angles to the feed screw 24 in the present embodiment. The engagement part 231 needs not extend so. The part 231 suffices to intersect with the pivot of the feed screw 24 so that the joint 23 may engages, at its side, with the screw portion 241 of the feed screw 24.

The engagement part 231 engages with the screw portion 241, not necessarily at a point where the top cover 32 intersects with the pivot of the feed screw 24. The engagement part 231 may incline to the top cover 32, engaging with the screw portion 241 at a position away from said point as illustrated in FIGS. 5 and 6. If this is the case, the engagement part 231 and projection 232 need not be arranged between the feed screw 24 and the top cover 32, and the disk drive 1 can be still thinner. Thus, the engagement part 231 and the screw portion 241 can engage with each other at any position, provided that the joint 23 oscillates to approach the top cover 32 when it receives vibration or an impact.

The guide parts 211 are supported by the support members 22 that extend along the opposing sides of the slide member 21, respectively. Instead, the guide part 211 located near the feed screw 24 may be directly supported by the feed screw 24 and allowed to slide on the feed screw 24. If so, the support member 22 extending along the feed screw 24 need not be used. This reduces the number of components of the disk drive 1 and, hence, the manufacturing cost thereof. The reduction in the number of components helps to render the disk drive 1 thinner or to provide an extra space for accommodating other components.

The disk drive 1 according to this embodiment is designed only to read (or reproduce) data. Instead, the disk drive 1 may be one that is configured only to record data or to read and record data. Further, the disk drive 1 may be modified in structure such that only the tray 34 moves from and into the housing, while the pickup feed mechanism 2, the disk-holding part 4 and the like are provided in the housing. In other words, the components of the disk drive 1 can be arranged in various ways. The pickup feed mechanism 2 can be used not only in the disk drive 1 that is thin because most parts are arranged in a plane parallel to the top cover 32, but also in any other types of disk drives.

The top cover 32 serves as the sole holding member in the present embodiment. Alterenatively, a part of the case 3 such as the bottom case 31 may work as a holding member. In this case, it suffices to arrange the engagement part 231 between the feed screw 24 and the bottom case 31, so that the engagement part 231 may contact the bottom case 31 before it moves away from the screw portion 241.

The holding member is a part of the case 3 in this embodiment. The case 3 may include a mechanical frame, nonetheless. That is, the projection 232, i.e., that part of the joint 23 which contacts the holding member, may abut on the mechanical frame.

The holding member is not limited to the case 3. Rather, a holding member may be provided between, for example, the joint 23 and the top cover 32. If so, however, some space should be provided for this holding member, making it difficult to render the disk drive 1 as thin as desired.

The rotation drive employed in this embodiment is the stepping motor 25. The stepping motor 25 may be replaced with any device that can rotate the feed screw 24. A DC motor, for example, may be used in place of the stepping motor 25.

Described above are the best configuration and best method that implement the present invention. Nevertheless, the invention is not limited to these. Although the invention has been described and shown in the form of a specific embodiment, one skilled in the art can make various changes and modifications, in terms of shape, material, the number of components, and the like, without departing from the scope and spirit of this invention.

Hence, the shape, material and the like, all specified above, are no more than examples described to facilitate the understanding of the invention, and would not limit the present invention. Thus, any component described above but not specified in terms of shape, material or the like falls within the scope of the present invention.

What is claimed is:

1. A pickup feed mechanism comprising:
a slide member holding a pickup for recording and/or reproducing data on and from a disk-shaped recording medium and configured to move the pickup in a radial direction of the disk-shaped recording medium;
a feed screw extending parallel to a direction in which the slide member is moved;
a rotation drive configured to rotate the feed screw;
a joint having two end portions, one end portion secured to the slide member and the other end portion intersecting with a pivot of the feed screw and having one side set in engagement with the feed screw; and;
a holding member arranged in the position to prevent the joint from moving away from the screw portion of the feed screw,
wherein the holding member is a case member which contains the pickup, the slide member, the feed screw, the rotation drive, and the joint.

2. A pickup feed mechanism according to claim 1, wherein the case member has a flat part, the pickup, the slide member, the feed screw, the rotation drive and the joint are arranged along the flat part, and the case member is therefore thin.

3. A pickup feed mechanism according to claim 1, wherein the joint has a projection which is configured to abut on the holding member.

4. A pickup feed mechanism according to claim 1, wherein the joint has a projection which is configured to abut on the holding member.

5. A pickup feed mechanism according to claim 2, wherein the joint has a projection which is configured to abut on the holding member.

6. A disk drive comprising the pickup feed mechanism described in claim 1.

7. A disk drive comprising the pickup feed mechanism described in claim 2.

8. A disk drive comprising the pickup feed mechanism described in claim 3.

9. A disk drive comprising the pickup feed mechanism described in claim 4.

10. A disk drive comprising the pickup feed mechanism described in claim 5.
